(19) United States
(12) Patent Application Publication
(10) Pub. No.: US 2021/0048871 A1
(43) Pub. Date: Feb. 18, 2021

(54) POWER CONTROL METHOD AND POWER CONTROL SYSTEM

(71) Applicant: Panasonic Intellectual Property Management Co., Ltd., Osaka (JP)

(72) Inventor: Daiki SATO, Kyoto (JP)

(21) Appl. No.: 16/969,351

(22) PCT Filed: Feb. 14, 2018
(86) PCT No.: PCT/JP2018/004971

§ 371 Date: Aug. 12, 2020

(51) Int. Cl. G06F 1/3215; G06F 1/18; G06F 1/26; G06T 7/33

(52) U.S. Cl. CPC G06F 1/3215; G06F 1/189; G06T 2207/10004; G06T 7/33; G06F 1/266

(57) ABSTRACT

A power control method includes a first step of acquiring image data, a second step of determining a connection state of an external device to a power supply port based on the image data, and a third step of controlling power supply from the power supply port based on the determination result of the connection state. In addition, a power control system includes a power supply port capable of power supply to an external device, an imaging unit that captures an image including the periphery of the power supply port to generate image data, an image processor that determines a connection state of the external device to the power supply port based on the image data, and a power controller that controls the power supply from the power supply port based on the determination result of the connection state.

### TECHNICAL FIELD

The present disclosure relates to a power control method for a power supply port that performs power supply.

### BACKGROUND ART

In recent years, many electronic devices each have a connection terminal (hereinafter referred to as a power supply port) capable of power supply such as a universal serial bus (USB) (registered trademark) as an interface. There is a method of determining whether or not an external device (device) is connected to the power supply port, based on the value of a load current flowing from the power supply port to the external device. However, when the battery of the external device connected to the power supply port reaches full charge, the load current becomes a minute value, and this value varies depending on the type of the external device and aging. Since there are various types of external devices and it is difficult to predict new external devices that will appear due to technological advances, it has been difficult to determine whether or not the external device is connected to the power supply port in consideration of the load currents of all these external devices.

PTL 1 discloses a power supply method for detecting whether an external device is connected to a port or the connection is released, when detecting that the external device is connected to the port, determining whether or not setting information corresponding to the external device is stored in a storage unit, and when it is determined that the setting information is stored in the storage unit, supplying power to a power supply circuit capable of supplying power to the port, when an information processing device shifts to a non-operable state.

### CITATION LIST

### Patent Literature

PTL 1: Unexamined Japanese Patent Publication No. 2011-34601

### SUMMARY OF THE INVENTION

The present disclosure provides a power control method and a power control system that control supplied power according to the connection state of an external device to a power supply port.

The power control method according to the first aspect of the present disclosure includes a first step of acquiring image data, a second step of determining a connection state of an external device to a power supply port based on the image data, and a third step of controlling power supply from the power supply port based on the determination result of the connection state.

The power control method according to the second aspect of the present disclosure is a power control method in a connection device that includes a first power supply port having a first power supply capability, and a second power supply port having a second power supply capability higher than the first power supply capability. The power control method includes a first step of acquiring image data corresponding to an image including the periphery of the first power supply port, a second step of determining a connection state of an external device to the first power supply port based on the image data, and a third step of limiting the second power supply capability of the second power supply port when the determination result of the connection state indicates a state in which the external device is connected to the first power supply port.

Further, the power control system of the present disclosure includes a power supply port capable of power supply to an external device, an imaging unit that captures an image including the periphery of the power supply port to generate image data, an image processor that determines the connection state of the external device to the power supply port based on the image data, and a power controller that controls the power supply from the power supply port based on the determination result of the connection state.

The power control method and the power control system of the present disclosure can control power supply according to the connection state of the external device to the power supply port.

### BRIEF DESCRIPTION OF DRAWINGS

FIG. 1 is a schematic diagram of a power control system according to a first exemplary embodiment.

FIG. 2 is a block diagram showing a configuration of the power control system according to the first exemplary embodiment.

FIG. 3 is a flowchart showing a power control method performed by the power control system according to the first exemplary embodiment.

FIG. 4A is a diagram illustrating an area imaged by an imaging device of the power control system according to the first exemplary embodiment.

FIG. 4B is a diagram illustrating an area imaged by the imaging device of the power control system according to the first exemplary embodiment.

FIG. 4C is a diagram illustrating an area imaged by the imaging device of the power control system according to the first exemplary embodiment.

FIG. 5 is a diagram illustrating an effect of the power control method performed by the power control system according to the first exemplary embodiment.

FIG. 6 is a block diagram showing a configuration of a power control system according to a second exemplary embodiment.

FIG. 7 is a diagram illustrating a power supply mode of the power control system according to the second exemplary embodiment.

FIG. 8 is a flowchart showing a power control method performed by the power control system according to the second exemplary embodiment.

FIG. 9 is a diagram illustrating a relationship between a power supply port connection state and a power supply mode by the power control method according to the second exemplary embodiment.

FIG. 10 is a diagram illustrating an effect of a power control method according to another exemplary embodiment.

### DESCRIPTION OF EMBODIMENTS

Exemplary embodiments will now be described below in detail with reference to the drawings as appropriate. However, descriptions in more detail than necessary may be omitted. For example, detailed descriptions of well-known matters and duplicate descriptions of substantially identical configurations may be omitted. This is to avoid unnecessarily redundancy in the following description, and to facilitate understanding by those skilled in the art.

The inventor of the present disclosure provides the accompanying drawings and the following description in order to allow those skilled in the art to fully understand the present disclosure, and do not intend to limit the subject matter described in the appended claims by the accompanying drawings and the following description.

### First Exemplary Embodiment

### 1-1. Configuration of Power Control System

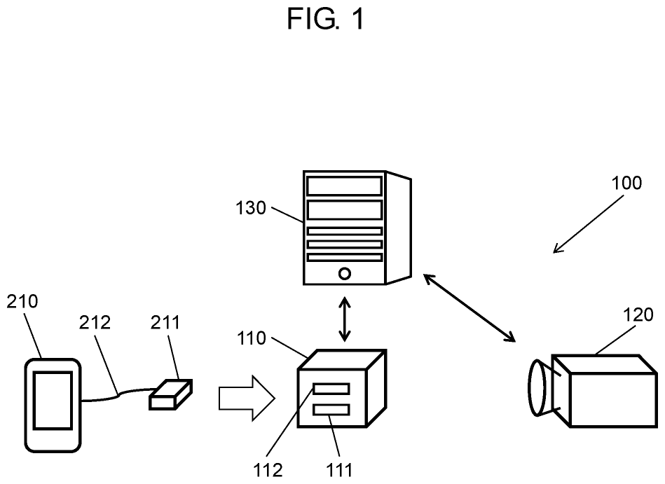

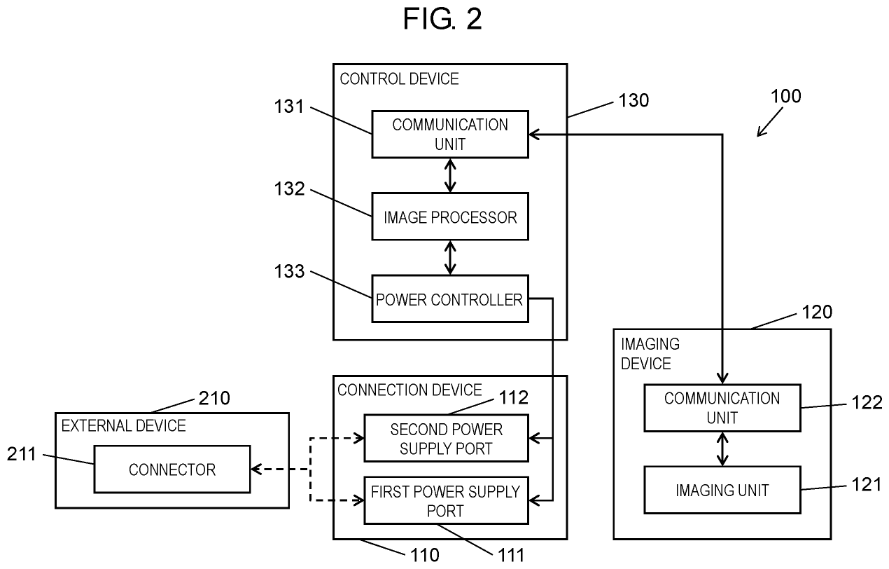

FIG. 1 is a schematic diagram of a power control system according to a first exemplary embodiment, and FIG. 2 is a block diagram showing a configuration of the power control system according to the first exemplary embodiment. Power control system 100 according to the first exemplary embodiment includes connection device 110, imaging device 120, and control device 130.

Connection device 110 has two power supply ports (first power supply port 111 and second power supply port 112) which are connection terminals capable of power supply. In the first exemplary embodiment, as first power supply port 111 and second power supply port 112, a USB terminal having a power supply function is described as an example, but the present invention is not limited to this, and any connection terminal capable of power supply (for example, IEEE1394) may be used. Further, in the first exemplary embodiment, the types of the two power supply ports may be the same or different. Further, a number of the two power supply ports may be one, or may be three or more. First power supply port 111 and second power supply port 112 are examples of power supply ports.

Connector 211 of external device 210 is connected to first power supply port 111 or second power supply port 112 of connection device 110. Connector 211 is connected to external device 210 via cable 212. Connector 211 is inserted into either first power supply port 111 or second power supply port 112. In the first exemplary embodiment, a case where connector 211 is inserted into first power supply port 111 will be described as an example, but the same applies to a case where connector 211 is inserted into second power supply port 112. When connector 211 is connected to first power supply port 111, connection device 110 supplies power to external device 210 via first power supply port 111 and connector 211. A specific example of external device 210 is a smartphone, a portable music player, or the like, but when the power supply port is a USB terminal, any kind of device may be used as long as it has a USB plug connectable to the USB terminal as connector 211.

Imaging device 120 has imaging unit 121 and communication unit 122, as shown in FIG. 2. Imaging device 120 captures an image including the periphery of first power supply port 111 or second power supply port 112 of connection device 110 by imaging unit 121, generates its image data, and transmits the image data to control device 130 via communication unit 122. Specific examples of imaging device 120 include a digital camera and a digital video camera. Imaging unit 121 forms an optical image of a subject on an image pickup device such as a charge-coupled device (CCD), and the image pickup device converts the optical image into image data.

As shown in FIG. 2, control device 130 has communication unit 131, image processor 132, and power controller 133. Control device 130 receives image data from imaging device 120 via communication unit 131, image processor 132 performs image determination, and power controller 133 controls power supply to the power supply port of connection device 110 based on the image determination result. The determination in the first exemplary embodiment is determination of the connection state of connector 211 of external device 210 to first power supply port 111 or second power supply port 112. A specific example of control device 130 is an information processing device such as a server or a personal computer (PC).

Communication unit 131 transmits the image data received from imaging device 120 to image processor 132. The image data may be stored in a storage unit (not shown) and then transmitted to image processor 132. The communication between communication unit 131 of control device 130 and communication unit 122 of imaging device 120 may be performed wirelessly or by wire.

Image processor 132 analyzes the image data transmitted from imaging device 120 via communication unit 131, and determines whether or not connector 211 of external device 210 is connected to first power supply port 111 or second power supply port 112. Then, the determination result is transmitted to power controller 133. Details of image data analysis and determination will be described later.

Based on the determination result transmitted from image processor 132, power controller 133 transmits an instruction regarding power supply at the power supply port to connection device 110. When the power supply port is the USB terminal, power controller 133 instructs the USB terminal to enable or disable the power supply function.

### 1-2. Control Method of Power Supply

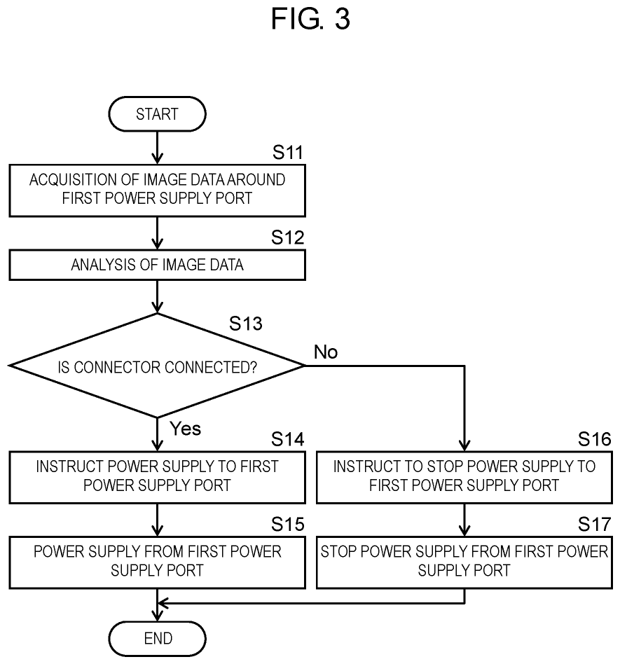

Next, a power control method executed in power control system 100 will be described. FIG. 3 is a flowchart showing a power control method performed by the power control system according to the first exemplary embodiment.

First, control device 130 acquires image data including the periphery of first power supply port 111 of connection device 110 imaged by imaging device 120 (step S11). The image data is transmitted from imaging device 120 to image processor 132 of control device 130 via communication unit 122 and communication unit 131, so that image processor 132 of control device 130 acquires the image data. The imaging by imaging device 120 may be performed in real time, periodically at a predetermined timing, or at any time according to a user's instruction. Further, control device 130 may control the imaging by imaging device 120.

Next, control device 130 analyzes the image data in image processor 132 (step S12), and determines whether or not connector 211 of external device 210 is connected to first power supply port 111 (step S13). The determination as to whether connector 211 is connected to first power supply port 111, that is, whether or not connector 211 is inserted into first power supply port 111 is performed by, for example, pattern matching. A specific determination method will be described later.

When it is determined in step S13 that connector 211 is connected to first power supply port 111 (Yes in step S13), control device 130 causes power controller 133 to instruct connection device 110 to perform power supply in first power supply port 111 (step S14). Then, connection device 110 performs power supply from first power supply port 111 (step S15).

In step S13, when it is determined that connector 211 is not connected to first power supply port 111 (No in step S13), control device 130 causes power controller 133 to instruct connection device 110 to stop the power supply to first power supply port (step S16). Then, connection device 110 stops the power supply from first power supply port 111 (step S17).

### 1-3. Analysis and Determination of Image Data

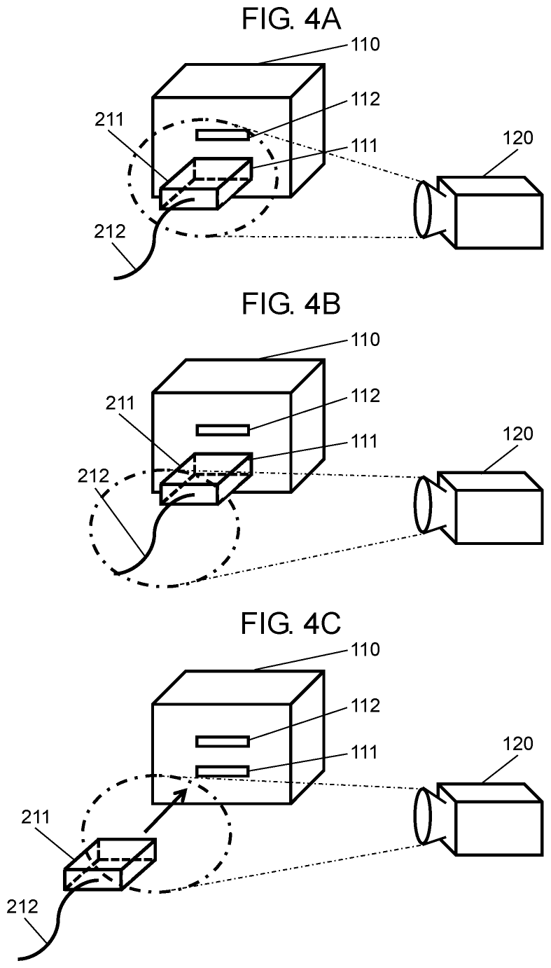

Next, the analysis and determination of image data performed by image processor 132 of control device 130 in step S13 will be described. FIGS. 4A to 4C are diagrams showing areas imaged by the imaging device of the power control system according to the first exemplary embodiment.

The example shown in FIG. 4A is a case where imaging device 120 captures an image of an area including an insertion port of first power supply port 111 (the portion where connector 211 is inserted) and determines the connection between first power supply port 111 and connector 211. In this case, an image of the state in which connector 211 is inserted into the insertion port of first power supply port 111 (reference image) is captured, and its image data (reference image data) is stored in the storage unit of control device 130. Then, the connection state is determined by performing pattern matching between the reference image data and the image data of the image to be determined (determination image) to calculate a matching rate. When the matching rate of the image data is high, it can be determined that connector 211 or cable 212 exists at a predetermined position.

The image including the insertion port of first power supply port 111 is greatly different depending on whether connector 211 is inserted into the insertion port of first power supply port 111 or not. This is because light is not reflected by connector 211 when connector 211 is not inserted into first power supply port 111. Therefore, the connection state can be determined by pattern matching of the image data of that portion. Here, the area including the insertion port of first power supply port 111 is an example of the periphery of the power supply port.

The example shown in FIG. 4B is a case where the connection between first power supply port 111 and connector 211 is determined by imaging device 120 capturing an image including an area where cable 212 of connector 211 is connected in the state where connector 211 is inserted into first power supply port 111 (the area of connector 211 on a side not inserted into first power supply port 111). In this case, in the state where connector 211 is inserted into the insertion port of first power supply port 111, an image (reference image) of the area where cable 212 of connector 211 is connected is captured, and its reference image data is stored in the storage unit of control device 130. Then, the connection state is determined by performing pattern matching between the reference image data and the image data of the image to be determined (determination image) to calculate a matching rate. When the matching rate of the image data is high, it can be determined that connector 211 or cable 212 exists at a predetermined position.

Also in this case, the image including the area where cable 212 of connector 211 is connected in the state where connector 211 is inserted into first power supply port 111 is greatly different depending on whether connector 211 is inserted into first power supply port 111 or not. This is because light is not reflected by connector 211 in the state where connector 211 is not inserted into first power supply port 111. Therefore, the connection state can be determined by pattern matching of the image data of the image. Here, the area where cable 212 of connector 211 is connected in the state where connector 211 is inserted into first power supply port 111 is an example of the periphery of the power supply port.

In this way, when it is difficult to image the area including the insertion port of the power supply port (see FIG. 4A) from the positional relationship between connection device 110 and imaging device 120, it is possible to determine the connection state between first power supply port 111 and connector 211 by imaging the area where cable 212 of connector 211 is connected. In the first exemplary embodiment, connector 211 to which cable 212 is connected has been described as an example, but in the case of a connector to which cable 212 is not connected, the same effect can be obtained by imaging the side not inserted into the power supply port of the connector.

In the example shown in FIGS. 4A and 4B, the image in which connector 211 is inserted into first power supply port 111 was used as the reference image data, but the reference image data may be generated by capturing an image in a state where connector 211 is not inserted into the insertion port of first power supply port 111, or the reference image data may be generated for both the state where connector 211 is inserted and the state where connector 211 is not inserted.

Further, in the example shown in FIGS. 4A and 4B, it is determined whether or not connector 211 or cable 212 is present at a predetermined position from the matching rate of the image data by pattern matching, but the connection state may be determined based on the distance from first power supply port 111 to connector 211 or cable 212. Specifically, the connection state of connector 211 is determined by comparing the distance from first power supply port 111 to connector 211 or cable 212 calculated from the reference image data, with the distance from first power supply port 111 to connector 211 or cable 212 calculated from the determination image data.

The example shown in FIG. 4C is a case where imaging device 120 captures an image in front of the insertion port (a portion where connector 211 is inserted) of first power supply port 111 to generate a plurality of pieces of image data, and control device 130 determines the connection state between first power supply port 111 and connector 211 by analyzing the plurality of pieces of image data and detecting a moving direction of an object in front of first power supply port 111. Specifically, when movement of connector 211 or cable 212 approaching first power supply port 111 is detected, it is determined that first power supply port 111 and connector 211 are in the connected state. On the contrary, when the movement of connector 211 or cable 212 away from first power supply port 111 is detected, it is determined that the connected state between first power supply port 111 and connector 211 is released. Here, the front of the insertion port of first power supply port 111 is an example of the periphery of the power supply port.

The image determination examples shown in FIGS. 4A to 4C may be used alone or in combination.

### 1-4. Effects etc.

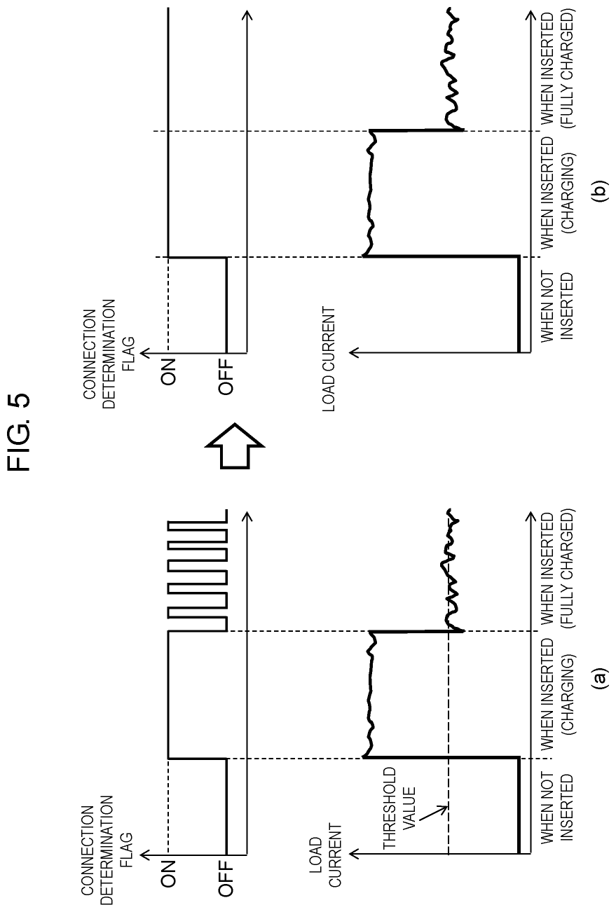

FIG. 5 is a diagram illustrating an effect of the power control method performed by the power control system according to the first exemplary embodiment. FIG. 5 shows the case where the connector of the external device is inserted into the power supply port of the connection device, and the load current flows from the connection device to the external device (during charging), and the external device has reached the fully charged state over time. Part (a) of FIG. 5 shows the conventional connection determination based on the threshold value of the load current, and part (b) of FIG. 5 shows the connection determination by analyzing the image data of the first exemplary embodiment. As shown in part (a) of FIG. 5, when the connection between the power supply port and the connector is determined based on the threshold value of the load current, the determination becomes unstable if the load current at full charge is near the threshold value. On the other hand, in the connection determination by analyzing the image data according to the first exemplary embodiment, the determination is stable regardless of the load current, as shown in part (b) of FIG. 5.

### Second Exemplary Embodiment

### 2-1. Configuration of Power Control System

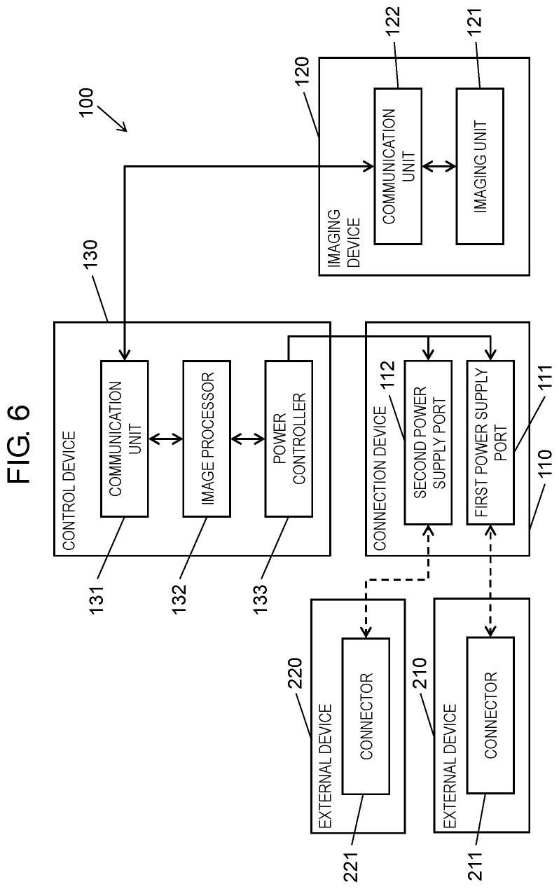

FIG. 6 is a block diagram showing a configuration of a power control system of a second exemplary embodiment. The configuration of the power control system according to the second exemplary embodiment is the same as that of power control system 100 (see FIG. 1) described in the first exemplary embodiment, and therefore the description thereof will be omitted, and different points of the power control method will be described. In the second exemplary embodiment, as shown in FIG. 6, a case where connector 211 of external device 210 is connected to first power supply port 111 and connector 221 of external device 220 is connected to second power supply port 112 is explained as an example.

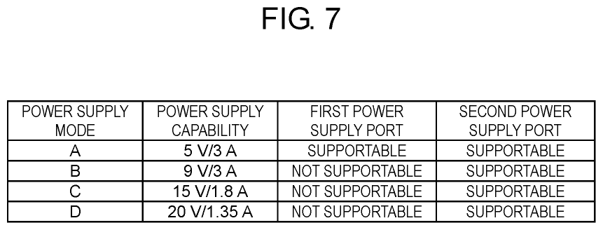

FIG. 7 is a diagram illustrating a power supply mode of the power control system according to the second exemplary embodiment. In the second exemplary embodiment, as shown in FIG. 7, first power supply port 111 and second power supply port 112 of power control system 100 have different power supply capabilities. Specifically, first power supply port 111 supports only power supply mode A (5V/3 A), and second power supply port 112 supports four power supply modes A to D (power supply mode A: 5V/3 A, power supply mode B: 9V/3 A, power supply mode C: 15V/1.8 A, power supply mode D: 20V/1.35 A). That is, second power supply port 112 has a higher power supply capability (second power supply capability) than the power supply capability of first power supply port 111 (first power supply capability).

### 2-2. Control Method of Power Supply

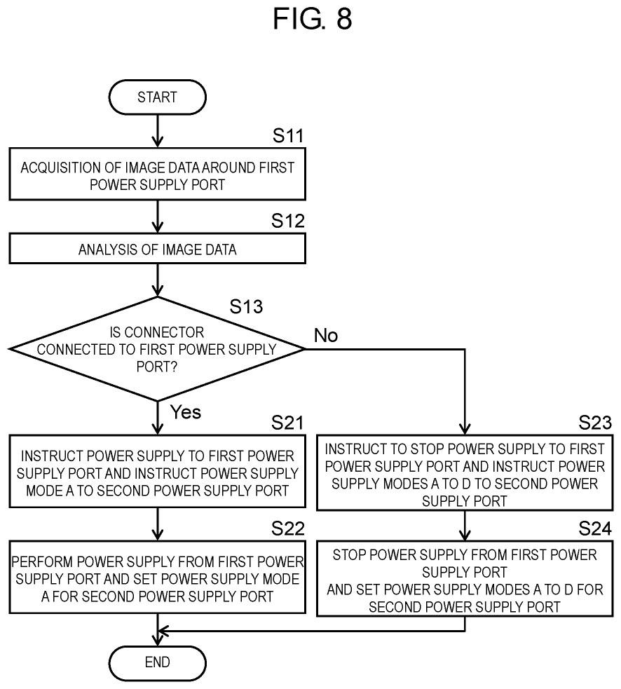

Next, a power control method according to the second exemplary embodiment executed in power control system 100 will be described. FIG. 8 is a flowchart showing a power control method according to the second exemplary embodiment performed by the power control system. Steps S11 to S13 that are the same as those in the power control method described in the first exemplary embodiment are assigned the same reference numerals and description thereof will be omitted.

In the determination of whether connector 211 of external device 210 is connected to first power supply port 111 in step S13, when it is determined that connector 211 is connected (Yes in step S13), control device 130 causes power controller 133 to instruct connection device 110 to perform power supply in first power supply port 111, and to set a power supply mode that second power supply port 112 can support (step S21). Then, connection device 110, based on the instruction from control device 130, performs power supply from first power supply port 111 to external device 210 and sets the power supply mode that second power supply port 112 can support (step S22). In the second exemplary embodiment, specifically, power supply mode A with the lowest power supply capability is set for second power supply port 112.

In this case, in the state where external device 210 is connected to first power supply port 111, even if another external device 220, which is connected to second power supply port 112 with connector 221 of another external device 220 inserted into second power supply port 112, is a device that supports charging by power supply mode D, control device 130 performs power supply by power supply mode A to external device 220 connected to second power supply port 112. That is, when external device 210 is connected to first power supply port 111, the power supply capability of second power supply port 112 is limited to the power supply capability of first power supply port 111. When the power supply capability of second power supply port 112 is limited, the power supply capability of second power supply port 112 may be limited to less than or equal to the power supply capability of first power supply port 111, as long as second power supply port 112 has a corresponding power supply mode.

On the other hand, in determination in step S13 of whether or not connector 211 of external device 210 is connected to first power supply port 111, when it is determined that connector 211 is not connected (No in step S13), control device 130 causes power controller 133 to instruct connection device 110 to stop the power supply in first power supply port 111, and to set a power supply mode that second power supply port 112 can support (step S23). Then, connection device 110, based on the instruction from control device 130, stops the power supply from first power supply port 111 and sets a power supply mode that second power supply port 112 can support (step S24). In the second exemplary embodiment, specifically, all power supply modes A to D that can be supported are set for second power supply port 112.

Therefore, in a case where external device 210 is not connected to first power supply port 111, when connector 221 of external device 220 that supports charging by power supply mode D is inserted into second power supply port 112, power supply is performed by power supply mode D from second power supply port 112 of connection device 110 to external device 220. That is, when external device 210 is not connected to first power supply port 111, the power supply capability of second power supply port 112 is not limited.

### 2-3. Effects etc.

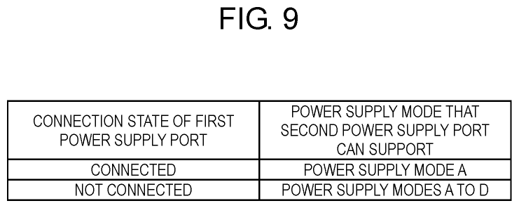

As described above, in the power control method according to the second exemplary embodiment, the connection state of the first power supply port is determined by analyzing the image around the first power supply port, and the power supply capability of the second power supply port is controlled according to the connection state of the first power supply port indicated by the determination result. FIG. 9 is a diagram illustrating the relationship between the connection state of the power supply port and the power supply mode by the power control method according to the second exemplary embodiment. As shown in FIG. 9, when an external device that supports power supply mode A (5V/3 A) is connected to the first power supply port, the second power supply port is set to power supply mode A, even if an external device that supports power supply mode D (20V/1.35 A) is connected to the second power supply port, power supply is performed by power supply mode A.

By controlling the power supply capability in this way, the power supply capability of the second power supply port is limited to the level of power supply mode A, and thus it is possible to suppress power consumption of the connected device while performing safe charging. The lower power consumption suppresses heat generation of the connected device and extends the life of the connected device body and components used in the device.

### Other Exemplary Embodiments

The exemplary embodiments have been described above as an example of the technique disclosed in the present application. However, the technique according to the present disclosure is not limited to the above exemplary embodiments, but is applicable to other exemplary embodiments including appropriate modifications, replacements, additions, omissions, and the like. In addition, new exemplary embodiments can be made by combining constituent elements described in the above exemplary embodiments. Accordingly, other exemplary embodiments will be described below.

In the above exemplary embodiments, the power control method has been described by taking the USB terminal as an example of the power supply port capable of power supply, but the power control method of the present disclosure is also applicable to another power supply port capable of power supply. For example, as an example of the power supply port, the present invention is also applicable to a power socket (outlet) that supplies power at AC 100V. That is, image data including an image around the power socket is acquired, the connection state of the power plug of the external device to the power socket is determined based on the image data, and the availability of power supply from the power socket can be controlled based on the determination result. Here, the power plug corresponds to the connector described in the above exemplary embodiments.

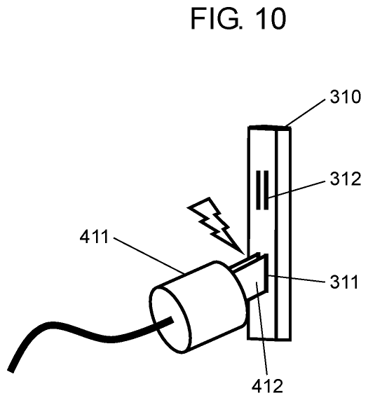

FIG. 10 is a diagram illustrating an effect when the power control method of the present disclosure is applied to a power socket. FIG. 10 shows a state in which power plug 411 is inserted into power socket 311 of connection device 310 that supplies AC power, but is not properly inserted (half insertion). In such a half-inserted state, part of plug terminal 412 (exposed portion E) of power plug 411 is exposed from power socket 311. Therefore, if a part of the human body touches exposed portion E, electric shock may occur. If there is a metal member in contact with exposed portion E, a short circuit may occur. Therefore, if the power control method of the above-described exemplary embodiments is applied, the connection state between power socket 311 and power plug 411 can be appropriately determined by image determination. Then, when power plug 411 is in the half-inserted state, the power supply from power socket 311 is controlled to be stopped, so that the problem of electric shock or short circuit due to exposed portion E can be prevented.

In the above exemplary embodiments, the case where one imaging device 120 images one connection device 110 has been described, but the power control system of the present disclosure is not limited to this. For example, one imaging device 120 may image a plurality of connection devices 110. In this case, for one connection device, as shown in FIG. 4A, an image of the surrounding area including the insertion port of the power supply port is captured, and for another connection device, as shown in FIG. 4B, an image of a portion to which the cable of the connector inserted into the power supply port is connected may be captured. Further, when one connection device has a plurality of power supply ports, an imaging device or an imaging unit may be assigned to each power supply port.

In the above exemplary embodiments, connection device 110, imaging device 120, and control device 130 included in the power control system have been described as individual devices, but the power control system of the present disclosure is not limited to this. Connection device 110, imaging device 120, and control device 130 may be integrally configured, or any two of these three devices may be integrally configured. In this case, the power supplies provided in each of connection device 110, imaging device 120, and control device 130 may be integrated and commonly configured.

The exemplary embodiments have been described above as examples of the technique in the present disclosure. For that purpose, the accompanying drawings and detailed description have been provided.

Accordingly, the constituent elements described in the accompanying drawings and the detailed description may include not only the constituent elements essential for solving the problem but also constituent elements that are not essential for solving the problem in order to illustrate the technique. It should not be therefore determined that the unessential constituent elements in the accompanying drawings and the detailed description are essential only based on the fact that these constituent elements are included in the drawings and the description.

The above exemplary embodiments are provided to exemplify the technique according to the present disclosure, and various changes, replacements, additions, omissions, and the like can be made within the scope of the claims and equivalents thereof.

### INDUSTRIAL APPLICABILITY

The present disclosure can be applied to power supply control for connection terminals capable of power supply, such as a USB terminal and a power socket.

### REFERENCE MARKS IN THE DRAWINGS

100: power control system

110, 310: connection device

111: first power supply port

112: second power supply port

120: imaging device

121: imaging unit

122: communication unit

130: control device

131: communication unit

132: image processor

133: power controller

210, 220: external device

211, 221: connector

212: cable

311: power socket

411: power plug

412: plug terminal

1. A power control method comprising:
a first step of acquiring image data;
a second step of determining a connection state of an external device to a power supply port, based on the image data; and
a third step of controlling power supply from the power supply port, based on the determination result of the connection state.

2. The power control method according to claim 1, wherein
the image data is generated by capturing an image including a periphery of the power supply port, and
in the third step, (i) when the determination result of the connection state indicates a state in which the external device is connected to the power supply port, power supply is performed from the power supply port, and (ii) when the determination result of the connection state indicates a state in which the external device is not connected to the power supply port, the power supply from the power supply port is stopped.

3. A power control method in a connection device including a first power supply port having a first power supply capability, and a second power supply port having a second power supply capability higher than the first power supply capability, the power control method comprising:
a first step of acquiring image data corresponding to an image including a periphery of the first power supply port;
a second step of determining a connection state of an external device to the first power supply port, based on the image data; and
a third step of limiting the second power supply capability of the second power supply port, when the determination result of the connection state indicates a state in which the external device is connected to the first power supply port.

4. The power control method according to claim 3, wherein
the second power supply port is controlled based on a plurality of power supply modes, and
when the determination result of the connection state in the third step indicates a state in which the external device is connected to the first power supply port, the second power supply port is controlled by a power supply mode that has a capability less than or equal to the first power supply capability among the plurality of power supply modes.

5. The power control method according to claim 3, wherein
the second power supply port is controlled based on a plurality of power supply modes, and
when the determination result of the connection state in the third step indicates a state in which the external device is connected to the first power supply port, the second power supply port is controlled by a power supply mode that has a lowest power supply capability among the plurality of power supply modes.

6. The power control method according to claim 1, wherein the connection state is determined based on presence of a connector or a cable of the external device in a predetermined position in the image data.

7. The power control method according to claim 1, wherein the connection state is determined based on a distance between a connector or a cable of the external device and the power supply port in the image data.

8. The power control method according to claim 1, wherein the connection state is determined based on a movement of a connector or a cable of the external device in the image data.

9. A power control system comprising:
a power supply port capable of power supply to an external device;
an imaging unit that captures an image including a periphery of the power supply port to generate image data;
an image processor that determines a connection state of the external device to the power supply port based on the image data; and
a power controller that controls the power supply from the power supply port based on the determination result of the connection state.
